(19) United States
(12) Patent Application Publication
(10) Pub. No.: US 2018/0345813 A1
(43) Pub. Date: Dec. 6, 2018

(54) METHOD FOR CONTROLLING A PRECHARGING CIRCUIT OF AN INTERMEDIATE CIRCUIT IN A MOTOR VEHICLE AS WELL AS HIGH-VOLTAGE BATTERY HAVING THE PRECHARGING CIRCUIT AND MOTOR VEHICLE

(71) Applicant: AUDI AG, Ingolstadt (DE)

(72) Inventors: Stefan HACKNER, Greding (DE); Stefan DUENSBIER, Regensburg (DE)

(73) Assignee: AUDI AG, Ingolstadt (DE)

(21) Appl. No.: 15/979,861

(22) Filed: May 15, 2018

(30) Foreign Application Priority Data
May 30, 2017 (DE) 10 2017 209 070.7

(51) Int. Cl. B60L 11/18

(52) U.S. Cl. CPC B60L 11/1851

(57) ABSTRACT

A method for controlling a precharging circuit. An electric supply unit is coupled to an intermediate circuit having an intermediate circuit capacitance. Through a control unit for connecting the supply unit to the intermediate circuit, an electric current of the supply unit is initially conveyed via a precharging resistor of the precharging circuit and then the precharging resistor is bridged. Prior to a following renewed connection of the supply unit, an overheating criterion for the precharging resistor is checked and, when the overheating criterion is met, the connection is blocked.

### FIELD

The invention relates to a method for controlling a precharging circuit, by means of which an electric supply unit, such as, for example, a high-voltage battery, is coupled to an intermediate circuit. The electric supply unit and the intermediate circuit are situated in a motor vehicle. The invention also includes a high-voltage battery with the precharging circuit as well as a motor vehicle having the high-voltage battery.

### BACKGROUND

Prior to the connection or closing of the two main contactors of a high-voltage battery of a motor vehicle, the electrical intermediate circuit connected to the high-voltage battery must be precharged. The reason for this is that the intermediate circuit has an intermediate circuit capacitor, through which an intermediate circuit capacitance is provided, which, when the main contactors are directly connected, would bring about a charging current that is greater than a maximum allowed current strength. Therefore, during precharging, the high-voltage battery is initially connected to the intermediate circuit via an electric precharging resistor. By way of the precharging resistor, the resulting maximum current strength is limited to a predeterminable maximum value. Depending on the magnitude of the intermediate circuit capacitance in the intermediate circuit, a correspondingly large amount of energy must flow via the precharging resistor into the intermediate circuit. Because the precharging resistor heats up thereby, the precharging cannot be repeated as often as desired or rapidly in succession. The precharging resistor needs to cool down in between.

Such an overheating protection for a precharging resistor can be implemented by means of a counter, which is incremented for each connection of the high-voltage battery to the intermediate circuit, that is, with each precharging. After expiration of a fixed cooling time, the counter is decremented once again. If the high-voltage battery is then connected to the intermediate circuit repeatedly in succession in time intervals that are too short, so that, in this way, the precharging is repeated each time, the counting exceeds a threshold value, after which a renewed connection of the high-voltage battery is then blocked until the predetermined cooling time has elapsed. However, this happens independently of the actual temperature of the precharging resistor and therefore does not fully exploit possible temperature reserves.

An arrangement composed of an intermediate circuit and a high-voltage battery that is connected by means of a precharging circuit is known from DE 10 2012 008 626 A1, for example. It is described therein that a current flowing through the precharging resistor is monitored in order to detect a fault in the intermediate circuit and subsequently to discontinue the precharging.

Known from DE 102 20 255 A1 is a motor vehicle with a high-voltage battery and an intermediate circuit, in which a precharging circuit having a precharging resistor is utilized to charge the intermediate circuit capacitance in a controlled manner when the high-voltage battery is connected. Through monitoring of a gradient of the electric voltage over time, it is determined whether the intermediate circuit is free of faults.

Known from JP 2008 022 675 A is a method for determining the electric power that is converted in the precharging resistor during a precharging of an intermediate circuit and for calculating from said electric power a time value during which the repetition of a precharging needs to be blocked in order that the precharging resistor cools down sufficiently. For this purpose, the voltage difference between the high-voltage battery and intermediate circuit, on the one hand, and the current that has flowed through the precharging resistor, on the other hand, is measured. How favorable the cooling conditions are at a given moment is not taken into consideration in this method. In other words, the actual temperature at the current moment is not taken into consideration.

### SUMMARY

The invention is based on the object of preventing an overload of the precharging resistor in a motor vehicle having an electric supply unit and an intermediate circuit, in this case without needing to block the precharging unnecessarily.

Provided by the invention is a method for controlling a precharging circuit. In a motor vehicle, an electric supply unit is coupled to an intermediate circuit, which has the said circuit capacitance, by means of the precharging circuit in a way that is known in and of itself. The method according to the invention is suitable for different types of supply units. The supply unit can be a high-voltage battery or a fuel cell. “High voltage” is understood here to mean an electric voltage greater than 60 volts, in particular greater than 100 volts.

In order to connect the supply unit to the intermediate circuit, an electric current of the supply unit is initially passed through a control unit via a precharging resistor of the precharging circuit. Subsequently, the precharging resistor is bridged. Accordingly, the supply unit is then fully connected to the intermediate circuit. However, the precharging resistor has then heated up during the precharging. For this reason, prior to or during a following renewed connection of the supply unit, an overheating criterion for the precharging resistor is thus checked. When the overheating criterion is met, the renewed connection is blocked.

In accordance with the invention, as overheating criterion, it is checked whether a temperature of the precharging resistor lies above a predetermined threshold value. The temperature is determined indirectly on the basis of a thermal model of the precharging resistor, wherein the model receives, as an input parameter, measured values of the current recorded at different points in time.

Due to the invention, the advantage results that, when the ability of the precharging resistor to withstand loads is checked, its actual temperature constitutes the basis thereof and, as is known from the prior art, not only the power converted in the precharging resistor is regarded. An advantage here is that, for example, the cooling behavior of the precharging resistor is also taken into consideration. If, for example, electric power is converted in the precharging resistor, which, however, cools at a greater cooling rate, then the renewed connection can be permitted absolutely. For this purpose, in accordance with the invention, the model receives the respective value of at least one input parameter and then assigns a temperature value of the precharging resistor to the at least one input parameter or to the combination of input parameters.

The invention also includes enhancements, through which additional advantages ensue.

Because the temperature of the precharging resistor is determined indirectly via a thermal model, the precharging resistor itself is preferably sensor-free. This makes the precharging resistor especially cost-effective in terms of the provision or production thereof and/or simpler in terms of the technical design thereof. For example, the precharging resistor can be a so-called cement resistor.

An enhancement provides that the thermal model receives a particular ambient temperature as at least one input parameter. In this way, it is also possible to determine a cooling rate or a cooling gradient of the precharging resistor. Accordingly, it is also possible for the model to replicate the cooling behavior over time.

An enhancement provides that, as an ambient temperature, a temperature of a shunt resistor element and/or a temperature of a printed circuit board of the precharging circuit or is/are determined. The advantage thereby results that the temperature monitoring of the shunt resistor element and/or of the printed circuit board, which is provided in any case, can be doubly utilized in that it is also utilized for describing the ambient temperature of the precharging resistor in the model. This is possible in the case that the precharging resistor is arranged at a distance of less than 40 centimeters, in particular less than 30 centimeters, from the shunt resistor element and/or the printed circuit board.

An enhancement provides that the thermal model receives, as an input parameter, a time value and replicates the time course of a heating operation and/or of a cooling operation of the precharging resistor. Accordingly, at a point in time at which the supply unit is to be connected to the intermediate circuit, the actual temperature of the precharging resistor is given by the model. A re-heating for a connection is thus also replicated by the model.

An enhancement provides that, as the thermal model, a characteristic diagram is provided, which, in each case, assigns an output value of the temperature of the precharging resistor to each parameter input or to each input parameter combination. The advantage thereby results that a complicated mathematical relation or function does not need to be determined, but instead it is possible to assign, in each case, an output value for the temperature to each input parameter combination, regardless of other input parameter combinations. The characteristic diagram can be created as a table.

Accordingly, it is in particular preferably provided that the thermal model is calibrated by means of physical measurements. Such measurements of temperature values of the precharging resistor can then be entered in a characteristic diagram individually or independently of one another.

An enhancement provides that the blocking of the renewed connection is maintained for a predetermined cooling time period and is subsequently ended. It is thereby ensured that the precharging resistor can be cooled down at least for the cooling time period.

The invention also includes a special supply unit, namely, a high-voltage battery. The high-voltage battery according to the invention has a precharging circuit, which can be designed in a way that is known in and of itself. Furthermore, a control unit is provided, which is equipped for implementing an embodiment of the method according to the invention. The control unit can have at least one microcontroller and/or at least one microprocessor. Furthermore, the control unit can have a program code, which, when it is implemented by the control unit, is designed to implement the embodiment of the method according to the invention. The program code can be stored in a data memory of the control unit.

The invention also includes a motor vehicle with the high-voltage battery according to the invention. The motor vehicle according to the invention is preferably designed as an automobile, in particular, as a passenger car or truck.

### BRIEF DESCRIPTION OF THE FIGURE

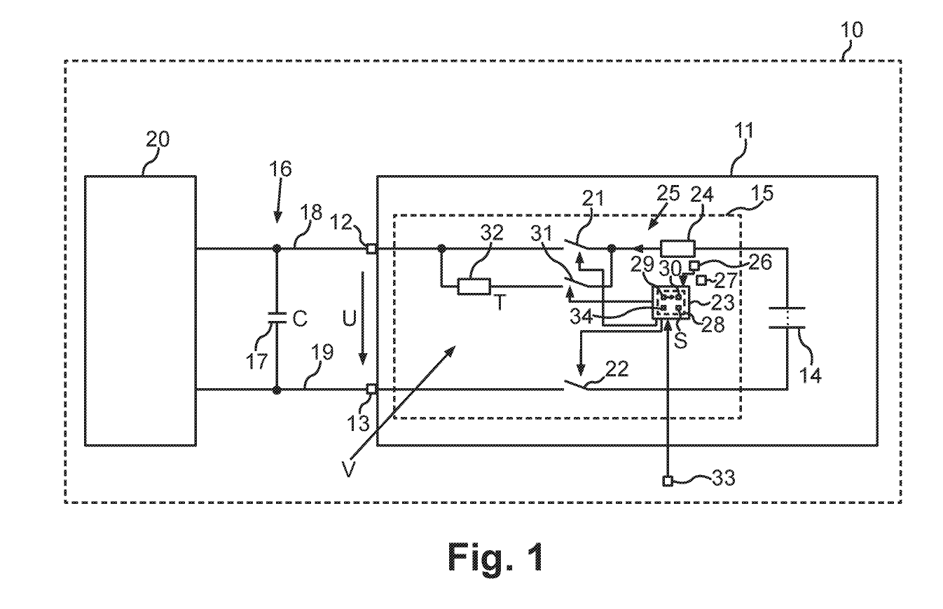

Described below is an exemplary embodiment of the invention. For this purpose, FIG. 1 shows a schematic illustration of an embodiment of the motor vehicle according to the invention.

### DETAILED DESCRIPTION

In the exemplary embodiments explained below, what is involved are preferred embodiments of the invention. In the exemplary embodiments, the described components of the embodiments each illustrate individual features of the invention, which are to be regarded as being independent of one another and which, in each case, the invention also further develops independently of one another and hence are to be regarded individually or in a combination differing from the combination shown as being a part of the invention Furthermore, the described embodiments can also be supplemented by additional features of the already described features of the invention.

FIG. 1 shows a motor vehicle 10, which can involve an automobile, in particular, a passenger car or a truck. The motor vehicle 10 can have an electric supply unit 11, for which what is involved is a high-voltage battery, that is, an electric battery or a rechargeable electric battery, which, at the output terminals 12, 13, can supply an electric direct-current voltage U that is greater than 60 volts and, in particular, greater than 100 volts. For this purpose, the supply unit 11 can have battery cells 14 in a way that is known in and of itself. The battery cells 14 can be connected to the terminals 12, 13 via a connecting device 15.

At the output terminals 12, 13, an electric intermediate circuit 16 can be connected, in which, in a way that is known in and of itself, an intermediate circuit capacitor 17 can be connected between a positive cable 18 and a negative cable 19. The positive cable 18 can be connected to the output terminal 12, and the negative cable 19 to the output terminal 13. By way of the intermediate circuit capacitor 17, an intermediate circuit capacitance C is provided to the intermediate circuit 16. Via the intermediate circuit 16, the supply unit 11 can be connected to a vehicle component 20. The vehicle component 20 can be, for example, an electric converter for an electric motor or a traction drive.

The connecting device 15 can be equipped for galvanically separating the battery cells 14 from the output terminals 12, 13. For this purpose, electric contactors 21, 22 can be provided. The contactors 21, 22 can be controlled or switched by a control unit 23. By means of a shunt resistor 24, a current strength of an electric current 25 that flows from the battery cells 14 into the intermediate circuit 16 can be measured in a way that is known in and of itself. Furthermore, a temperature sensor 26 can be provided, by means of which a shunt temperature 27 of the shunt resistor 24 can be measured. The control unit 23 can have a printed circuit board 28, which likewise can have a temperature sensor 29 for recording a circuit board temperature 30.

For precharging of the intermediate circuit 16, that is, for throttling of the current 25 when the supply unit 11 is switched on or connected, the contactor 21 is not closed or switched to be electrically conductive together with the contactor 22, but, instead, initially for an open contactor 21 and a closed contactor 22, a switching element 31 is switched by the control unit 23 to be electrically conductive or closed by means of a precharging circuit 30. The switching element 31 can be a relay.

By way of the closed switching element 31, the current 25 bypasses the contactor 21 and is conveyed through a precharging resistor 32. The precharging resistor 32 results in a lower current strength of the current 25 than when the contactor 21 is closed. In this way, the current 25 for precharging the capacitance C is limited in terms of its current strength. Only when the capacitance C has been charged is the precharging circuit 30 bridged by means of the contactor 21. The battery cells 14 are then connected to the intermediate circuit 16 through a lower electrical resistance than in the case of the precharging resistor 32.

When the supply unit 11 is to be connected to the intermediate circuit 16 and therefore the intermediate circuit 16 is to be precharged and, subsequently, both contactors 21, 22 are to be closed, the supply unit 11 is specified via a switching signal 33. When the switching signal 33 is received, the control unit 23 can initially check the actual temperature T of the precharging resistor 32. Only in the case when the temperature T is lower than a threshold value S is the connection actually made; that is, the precharging is activated. Otherwise the connection is blocked; that is, the switching signal 33 is therefore ignored or remains without any effect. Therefore, an overheating criterion is provided by the threshold value S.

However, for the control unit 23, the temperature T does not need to be measured directly. Instead, the control unit 23 utilizes a thermal model 34, which, depending on input parameters, estimates a temperature value of the temperature T. As an input parameter, it is possible to use the current strength of the current 25 (determined by means of the shunt resistor 24), the temperatures 27, 30, and the time.

Thus, the current 25 that, during precharging, flows via the precharging resistor 32 can be measured and integrated, so that a numerical value or measured value for the ampere seconds is obtained. Via the known resistance value of the precharging resistor 32, it is possible to calculate the power dissipation in the precharging resistor 32.

However, in order to be able also to define precisely and/or to track or describe the heating behavior and/or cooling behavior under the different thermal boundary conditions or preconditions as well as the thermal heating in the precharging resistor 32, it is advisable to define the thermal simulation model or, in short, the thermal model 34 of the object to be protected, that is, of the precharging resistor 32, together with its surroundings. The surroundings are understood to mean here, in particular, the temperature 27, 30, which describes or causes the difference in temperature to that of the precharging resistor 32, and accordingly the cooling behavior and/or the heating behavior. Such a model 34 can be created, for example, in the form of a table or a characteristic diagram. The model can be reconciled or configured with physical measurements. The measured parameter values (temperatures, current values, times) then enter into this thermal model 34. Via this model 34, it is then possible to deduce the correct temperature T of the precharging resistor 32 at any point in time. Accordingly, the precharging resistor 32 can always be utilized to the full extent that its characteristic values or its maximum allowed temperature value permit or permits. Nonetheless, it is protected, because the control unit 23 can block the precharging.

Accordingly, it is not necessary to limit the number of precharging operations to a value that is safe in the worst case—for example, to connect a maximum of three times, followed by a minimum pause. Instead, the supply unit 11 can then be connected more often in the same period of time. The actual power dissipation converted in the precharging resistor 32 is determined and, in addition, also the development over time or the time course of the temperature T, that is, the cooling behavior and/or heating behavior, is/are also replicated by means of the model 34. Therefore, it is not necessary, for each precharging, actually to meet the worst-case assumption for the precharging; that is, it is not always necessary to assume a maximum possible power dissipation.

Because the current 25 is already measured in the connecting device 15, it is merely necessary to integrate said current by way of the control unit 23 by means of, for example, a microcontroller. The value can then be evaluated by means of the model 34.

Overall, the examples show how, through the invention, a protection of a precharging circuit of a high-voltage battery can be provided.

1. A method for controlling a precharging circuit, comprising:
an electric supply unit is coupled to an intermediate circuit having an intermediate circuit capacitance, wherein, through a control unit for connecting the supply unit to the intermediate circuit, an electric current of the supply unit is initially conveyed via a precharging resistor of the precharging circuit and then the precharging resistor is bridged, and wherein, prior to a following renewed connection of the supply unit, an overheating criterion for the precharging resistor is checked, and, when the overheating criterion is met, the connection is blocked, wherein as an overheating criterion, it is checked whether a temperature of the precharging resistor lies above a predetermined threshold value, wherein the temperature is determined indirectly on the basis of a thermal model of the precharging resistor, and the model receives, as an input parameter, measured values of the current that are recorded at different points in time.

2. The method according to claim 1, wherein the precharging resistor is operated sensor-free.

3. The method according to claim 1, wherein the model receives, as at least one input parameter, a particular ambient temperature.

4. The method according to claim 3, wherein, as the ambient temperature, a temperature of a shunt resistor element and/or a temperature of a printed circuit board of the precharging circuit is determined.

5. The method according to claim 1, wherein the model receives, as an input parameter, a time value, and the model replicates the time course of a heating operation and/or a cooling operation of the precharging resistor.

6. The method according to claim 1, wherein, as the model, a characteristic diagram is provided, which assigns an output value of the temperature to each input parameter combination.

7. The method according to claim 1, wherein the model is calibrated by physical measurements.

8. The method according to claim 1, wherein the blocking is maintained for a predetermined cooling time period and subsequently ended.

9. A high-voltage battery having a precharging circuit, which has a control unit, which is equipped to carry out a method according to claim 1.
